(19) United States
(12) Patent Application Publication
(10) Pub. No.: US 2023/0039187 A1
(43) Pub. Date: Feb. 9, 2023

(54) Leg Actuation Apparatus and Gait Rehabilitation Apparatus

(71) Applicant: Hocoma AG, Volketswil (CH)

(72) Inventors: Adrian Moser, Zurich (CH); Jan Frederik Veneman, Fallanden (CH)

(21) Appl. No.: 17/788,102

(22) PCT Filed: Dec. 23, 2020
(86) PCT No.: PCT/EP2020/087804

§ 371 Date: Jun. 22, 2022

(30) Foreign Application Priority Data
Dec. 23, 2019 (EP) 19219389.4

(51) Int. Cl. A61H 1/02

(52) U.S. Cl. CPC A61H 1/0262; A61H 2201/1215; A61H 2201/1642; A61H 2201/1635; A61H 2201/1652; A61H 2201/1671; A61H 2201/5061

(57) ABSTRACT

A leg actuation apparatus includes two driven axes, wherein onto each one a distal parallelogram mechanism is attached with one connector being attached in a torque proof manner, wherein the other end of the arm being rotatably connected to an intermediate axis. One proximal parallelogram mechanism is rotatably attached at each intermediate axis and at transfer axes connected to the leg attachment elements to be attached to the upper and lower leg of a user. The distal ends of the lower parallelogram mechanism and the distal ends of the upper parallelogram mechanism can freely glide along the respective first and second driven axis.

### CROSS-REFERENCE TO RELATED APPLICATIONS

This application is the United States national phase of International Application No. PCT/EP2020/087804 filed Dec. 23, 2020, and claims priority to European Patent Application No. 19219389.4 filed Dec. 23, 2019, the disclosures of which are hereby incorporated by reference in their entirety.

### BACKGROUND OF THE INVENTION

### Field of the Invention

The present invention relates to a leg actuation apparatus and a gait rehabilitation apparatus for driving and/or supporting a limb.

### Description of Related Art

WO 2014/202767 from the applicant discloses an apparatus for gait rehabilitation with a pelvis attachment fixed at the apparatus from behind and cuffs for the attachment of legs fixed at driven guide legs provided at the exterior of each leg of the user of the apparatus.

A gait rehabilitation apparatus using guide legs provided behind the legs of the user is disclosed in US 2015/0328078 A1. The guide leg is connected with cuffs at the legs via four attachment members provided at the guide hip joint, the guide knee joint, the guide ankle joint and the guide bottom foot.

EP 2 881 008 A1 relates to a walking training apparatus with a harness for the upper body and a seat for the user extending in front between the legs as a bicycle riding saddle. The legs of the user are connected via cuffs to a leg actuation mechanism comprising a three-dimensional parallelogram construction.

KR 2018 0026068 A relates to a walk rehabilitation device comprising: a basic frame; a first link rotationally connected to the basic frame and fixed to a thigh of a user; a second link rotationally connected to the first link and fixed to a calf of the user; a third link having one end connected to a first joint which revolves around a reference axis, and the other end connected to the first link; and a fourth link having one end connected to a second joint having a revolution orbit larger than the orbit of the first joint and revolving around the reference axis, and the other end connected to the second link. Movement of the first link and the second link that simulates an actual movement of a leg necessary for walking is performed by a relative movement of the third link and the fourth link as the first joint and the second joint revolve at the same revolution cycle.

KR 102 016 859 B1 relates to a walking assistance apparatus comprising: a body; a motion generation unit comprising a plurality of links and provided as a link structure rotatably connected to the body to generate a basic trajectory in a form of a closed curve that moves an area in a front-back direction and a vertical direction in accordance with rotation; a motion amplification unit connected to the motion generation unit and provided in a link structure to generate a walking trajectory by amplifying the basic trajectory in a predetermined form; and a motion unit provided in the link structure and connected to the motion amplification unit to be driven in a form corresponding to the walking trajectory.

### SUMMARY OF THE INVENTION

The leg actuation apparatus of the prior art are cumbersome to use, especially in view that usually the user is additionally to be supported to stand. The user is approached to a gait rehabilitation device while sitting in a chair and then he or she has to be lifted, perhaps already wearing a harness to be used in the gait rehabilitation device and then the leg actuation apparatus has to be mounted. This is complicated in the different prior art devices. Some prior art devices, especially from the applicant allow the user to sit while attaching him to the apparatus.

Based on this prior art it is an aim of the present invention to improve the usability of any gait rehabilitation apparatus using such leg actuation apparatus through proposing a new approach for attachment of the legs to the leg actuation apparatus. Furthermore, such leg actuation apparatus allows a more flexible movement of the user.

Such a leg actuation apparatus for a user has a leg actuation mechanism frame comprising: a first driven axis positioned transverse to the walking direction of said user, an upper attachment element for a first leg part of the user, comprising a transverse upper transfer axis, a distal upper parallelogram mechanism, comprising a distal upper support arm, a distal upper parallelogram connector, a distal upper connection leg part and a distal upper intermediate parallelogram connector, wherein one end of the distal upper support arm is attached in a rotatable manner at the first driven axis, wherein the other end of this distal upper support arm is providing an intermediate axis for the distal upper parallelogram mechanism, wherein one end of the distal upper parallelogram connector is connected to rotate in a torque proof manner with the first driven axis, wherein the distal upper connection leg part and the distal upper intermediate parallelogram connector are rotatably connected in series between the distal upper parallelogram connector and said intermediate axis, and a proximal upper parallelogram mechanism, comprising a proximal upper support arm, a proximal upper intermediate parallelogram connector, a proximal upper connection leg part and a proximal upper parallelogram connector, wherein one end of the proximal upper support arm is attached in a rotatable manner at the intermediate axis, wherein the other end of this proximal upper support arm is rotatably attached at the upper transfer axis, wherein the proximal upper intermediate parallelogram connector, a proximal upper connection leg part and a proximal upper parallelogram connector, are rotatably connected in series between said intermediate axis and said upper transfer axis, wherein the distal upper intermediate parallelogram connector and the proximal upper intermediate parallelogram connector are connected to rotate in a torque-proof manner and the proximal upper parallelogram connector and upper attachment element are connected to rotate in a torque-proof manner.

The transfer axis at the upper attachment element is defined as “upper transfer axis”. This is not an indication that the upper attachment element is provided for the upper leg of the user and a lower attachment element is provided for the lower leg. It is possible to provide a single attachment element for the lower leg and add later on a second attachment element for the upper leg.

One benefit of this apparatus comprises that no length adjustment according to patient dimensions is necessary for the mechanism. The apparatus can be installed in a seated position and in principle can support the sit to stand and stand to sit motions. The system allows freedom of the patient to walk forward/backward, or left or right relative to the center position on the treadmill or the ground, while always receiving consistent support in the sagittal plane.

In short, a leg actuation apparatus comprises one or more driven axes, wherein onto each one a distal parallelogram mechanism is attached with one arm being attached in a torque proof manner, wherein the other end of the arm being rotatably connected to an intermediate axis. One proximal parallelogram mechanism is rotatably attached at each intermediate axis and at transfer axes connected to the leg attachment elements to be attached to the upper and/or lower leg of a user, wherein the distal ends of the lower parallelogram mechanism and/or the distal ends of the upper parallelogram mechanism can freely glide along the respective first and second driven axis.

An advantage is that independent from the weight support unit used within a gait rehabilitation apparatus, the user can be initially “connected” to the weight support part of the gait rehabilitation apparatus and then the leg actuation apparatus for both legs can be easily attached from before the standing or seated user. The parallelogram apparatuses can be shifted transversely on the driven axes for easy connection of the leg holding cuffs in their correct transverse position and during movement of the user the upper and lower leg may not be entirely in line in the direction of walking.

The setup according to the invention avoids any need to match any joints between apparatus and patient. This entirely prevents all shear forces and discomforts that are caused by possible misalignment which means that the apparatus is far less dependent on quality of patient setup. The independency of position means no joint mismatch and no height adjustment, but that independent adjustments possible, etc. as mentioned above. This also reduces the setup time.

Instead of the above mentioned free gliding of the distal ends of the upper parallelogram mechanism, these distal ends of the upper parallelogram mechanism can be connected to an actuator for a driven movement along the first driven axis.

Furthermore, the device can comprise abutments for fixing the extreme positions of the distal ends of the upper parallelogram mechanism on the first driven axis to secure the limits of the movement of the leg of a user and especially avoiding damage to the knee.

The leg actuation apparatus can have a double distal parallelogram mechanism attached on the existing distal upper support arm. This double distal parallelogram mechanism comprises a double distal parallelogram connector, a double distal connection leg part and a double distal intermediate parallelogram connector, wherein one end of the double distal parallelogram connector is connected to rotate in a torque proof manner with the first driven axis. The double distal connection leg part and the double distal intermediate parallelogram connector are rotatably connected in series between the double distal parallelogram connector and said intermediate axis.

The terms upper and lower were chosen to differentiate between the two different actuation portions of the device. In the drawings of the embodiment shown, the difference between the “upper” and “lower” “actuation apparatus” is the double parallelogram in the lower. This extension of a parallelogram is used to allow a larger workspace, i.e. range of motion. In theory the upper apparatus could be attached to the lower leg, but it would limit the range of motion too much to walk normally. On the other side, the “lower” actuation solution solves a more complex problem than the upper, since it adds functionality. Therefore, this second parallelogram can be added to the “upper” actuation solution as well to extend the range of motion, which may be too limited in certain cases. So this double parallelogram can be applied at all links.

The angle between the distal parallelogram connector and the double distal parallelogram connector can be between 40 and 120 degrees, preferably between 60 and 120 degrees and especially 90 degrees. These 90 degrees would provide for the lowest possible force on the pushrods for a given torque. A reason for taking a different angle from the given intervals is to make parts fit for all four links and to make the pushrods go past the connection axels in all positions.

The proximal connection leg parts can each comprise a force sensor to measure the torques applied to upper and lower transfer axes. This allows for more control options, feedback and flexibility when applying the device with different users. In other embodiments the force sensor may be placed in the distal connection leg part or another part of the parallelogram mechanisms. The sensor can also be positioned onto the proximal rod to remove the need to run cables up the first link.

The legs actuation mechanism frame can comprise one or more abutments to limit the rotation of the driven axes, for the lower leg as well as for the upper leg, especially to limit the movement of the parallelogram mechanism to avoid overstretching the knee joint. This relates to the thigh-angle-dependant mechanical limit for the shank angle which allows a safe use of two otherwise independent torques.

The description of an “above ground” fixture embodiment in connection with FIG. 7 shows that the definition e.g. “lower leg” part or “upper leg” part in the specification and claims are only used to differentiate specific features as shown in the drawings FIGS. 1 to 6 and FIGS. 8 to 11. If a device according to these drawings is mounted above ground as shown in FIG. 7 based on the embodiment of FIG. 3, the role of lower and upper leg part become inverted.

Further embodiments of the invention are laid down in the dependent claims.

It is a further advantage of the leg actuation apparatus according to the invention that it can be applied within an apparatus for gait rehabilitation comprising a main frame providing a possibility for a user to receive body weight and postural support during walking within this main frame and two leg actuation apparatus according to the invention which are both being attached to the main frame, wherein one leg actuation apparatus comprises a first leg actuation mechanism frame for the right leg and the other leg actuation apparatus comprises a second leg actuation mechanism frame for the left leg. The main frame can comprise a tread mill, wherein a first leg actuation mechanism frame and optionally a second leg actuation mechanism frame is attached having the above mentioned features. The main frame can also comprise vertical pillars at the side of the main frame to provide a weight support mechanism to be attached to a body harness worn by the user. If there would be no treadmill as shown in the drawings, then the leg actuation mechanism frame can just be connected to rollers to allow the user to walk on the ground. WO 2008/040554 (A1) of the present applicant provides one possibility for such an assembly.

Such an apparatus for gait rehabilitation can further comprise a treadmill for the user to walk upon.

Such an apparatus for gait rehabilitation can also have a main frame comprising at least a set of rolling wheels defining the surface onto which the apparatus for gait rehabilitation is displaced by the walking user.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic perspective view of parts of a gait rehabilitation apparatus with a leg model, wherein a leg actuation apparatus for this gait rehabilitation apparatus is shown,

FIG. 2 shows a front view of FIG. 1;

FIG. 3 shows a side view of FIG. 1;

FIG. 4 shows a further side view similar to FIG. 3;

FIG. 5 shows a schematic view of the side view of FIG. 4;

FIG. 6 shows a detail side view of the attachment of the driven axes of FIG. 1;

FIG. 7 shows a schematic side view of parts of a second gait rehabilitation apparatus with a leg model similar to the embodiment as shown in FIG. 3 with an above ground mounting of the legs actuation mechanism frame;

FIG. 8 shows a front view of a portion of a different crank mechanism provided for a further embodiment of a leg actuation apparatus;

FIG. 9 shows a view from above on the mechanism according to FIG. 8 with the elements of the guide leg part;

FIG. 10 shows a side view on the mechanism according to FIG. 8, incorporating the connection at the intermediate lower leg connector axis; and

FIG. 11 shows a schematic perspective view of parts of a further gait rehabilitation apparatus for the upper leg, or to be used as a simpler version for the lower leg similar to FIG. 10.

### DESCRIPTION OF THE INVENTION

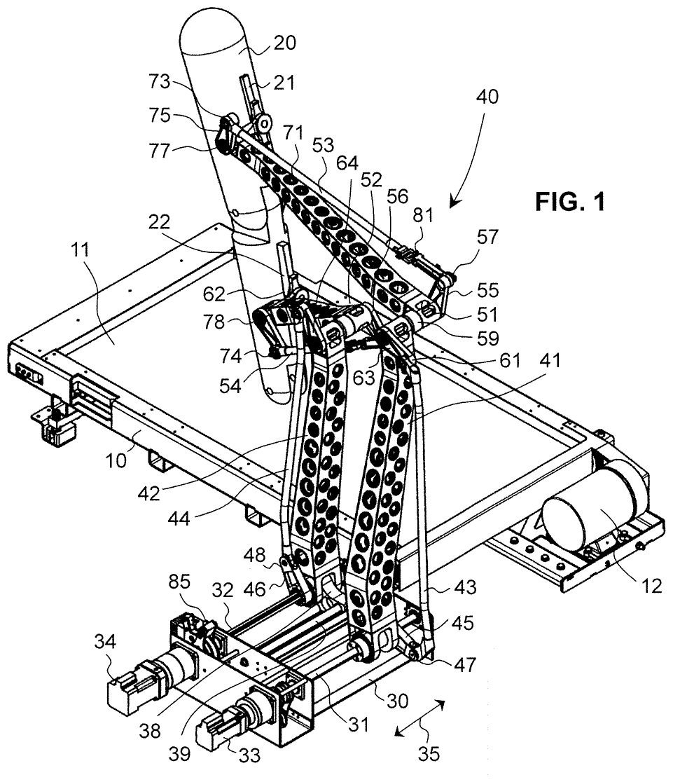

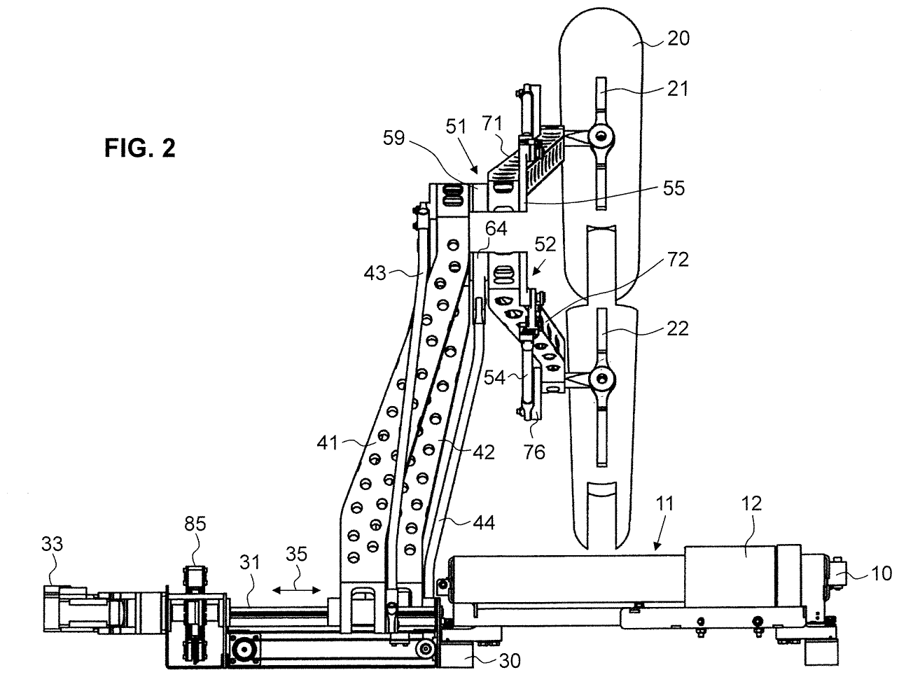

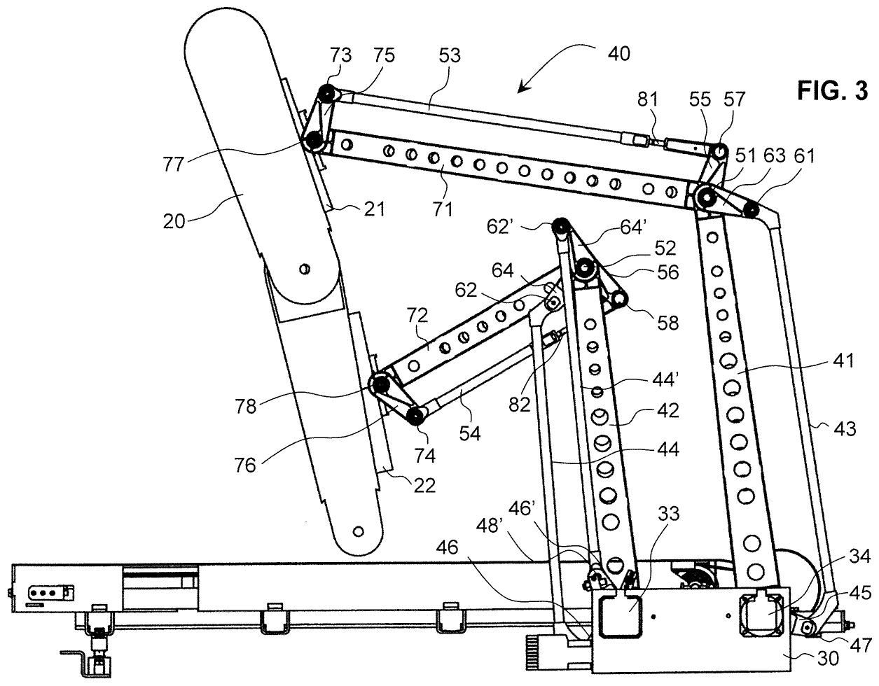

FIG. 1 shows a schematic perspective view of parts of a gait rehabilitation apparatus with a leg model 20. The main parts of a leg actuation apparatus according to an embodiment of the invention as part of the gait rehabilitation apparatus are shown. FIG. 2 shows a front view of FIG. 1 and FIG. 3 shows a side view of the leg actuation apparatus and the treadmill of the gait rehabilitation apparatus.

The gait rehabilitation apparatus is provided with a treadmill frame 10. The treadmill comprises a treadmill band 11 and a treadmill drive 12. The user is supposed to be suspended or supported from behind while standing and walking on the treadmill band 11. Only one right leg 20 is shown of such a user. The left leg would be on right hand side of FIG. 2.

During preparation of the gait rehabilitation, the user may sit on a chair, e.g. a wheelchair or a stool, which may be located on the treadmill or in an appropriate location close to the apparatus, as such sitting posture may make it easier and less exhausting to attach the apparatus. The user may then stand up and perform the rehabilitation with the apparatus after the chair is removed from the treadmill. Conversely, at the end of the rehabilitation the chair may be placed on the treadmill and the user can sit down, as this may make detachment of the apparatus easier. It should be noted that attachment and detachment of the apparatus is possible while the user is standing.

The leg actuation mechanism frame 30 is connected on the left hand side of FIG. 2 to the treadmill frame 10 and is connected, as will be discussed now, with the upper leg cuff attachment 21, generally mentioned as upper attachment element, and the lower leg cuff attachment 22, generally mentioned as lower attachment element, here both for the right leg. A similar further leg actuation mechanism frame 30 for the left leg may be attached on the left hand side of FIG. 2 if training of the left leg is desired, but not shown in the drawings. Other embodiments of the apparatus may comprise a mechanism for the left leg, but none for the right, or it may comprise a first mechanism for the right leg and a second apparatus for the left leg. The object of this leg actuation apparatus is the connection of axis 31 to attachment element 21 in a torque proof manner, in the sagittal plane. This follows from the torque proof connection between all in between connections; on the other side, the coupling to 21 can rotate freely in a range in the frontal plane.

The leg actuation mechanism frame 30 comprises a first driven axis 31 and a second driven axis 32, both provided in parallel to each other and in parallel to the driven axis of the treadmill, i.e. transverse to the marching direction of a user on the treadmill. The first driven axis 31 and a second driven axis 32 are both ending in a first respective second driven engagement 33 and 34, respectively.

The auxiliary axis connector 38 connects the second driven axis 32 with an auxiliary axis 39. In the embodiment depicted in FIGS. 1 and 2 the auxiliary axis connector 38 is provided on the driven axis between the arms of the distal guide leg 42. The auxiliary axis connector 38 can slide along the second driven axis 32 and the auxiliary axis 39. This sliding movement can be supported by an auxiliary drive (not shown).

A distal upper guide leg 41 and a lower distal guide leg 42 are connected to the first driven axis 31 and a second driven axis 32, respectively. The connection is such that rotating the axis 31 or 32 does not rotate the distal guide leg 41 or 42, respectively, but the distal upper guide leg 41 and the lower distal guide leg 42 can freely rotate around and slide along the respective axis 31 or 32.

It is possible to lock the upper guide leg 41 and the lower distal guide leg 42 on the driven axes 31 and 32, e.g. by means of locking abutments. It is also possible to actively drive the sliding movement of the upper guide leg 41 and the lower distal guide leg 42 in the direction of the driven axes 31 and 32 by e.g. providing actuators adjusting the length of connecting rods connected to the connecting parts of the upper guide leg 41 and the lower distal guide leg 42 with the respective driven axes. Then these actuators can also provide the locking action to maintain the upper guide leg 41 and the lower distal guide leg 42 on a chosen longitudinal position along the respective axis 31 or 32.

The distal upper guide leg 41 is connected with a proximal upper guide leg 71 and the distal lower guide leg 42 is connected with a proximal upper guide leg 72 at intermediate upper leg connector axis 51 and intermediate lower leg connector axis 52, respectively.

In parallel (not in the mathematical sense) to the distal upper guide leg 41 is provided a parallelogram connection comprising a distal parallelogram connector 45 extending from the first driven axis 31 to a distal parallelogram axis 47, an intermediate parallelogram connector 63 extending from intermediate upper leg connector axis 51 to an intermediate parallelogram axis 61 and a distal upper connection leg part 43 connecting said intermediate parallelogram axis 61 and the distal parallelogram axis 47.

In other words, distal parallelogram connector 45 is connected to the first driven axis 31 in such a manner that it rotates with the first driven axis 31 when this is rotated but can freely slide along the first driven axis 31. A splined shaft, grooved shaft, or other method that uses grooves or other patterns in the first driven axis 31 can be provided to achieve this connection.

In parallel (not in the mathematical sense) to the distal lower guide leg 42 is provided a parallelogram connection comprising a distal parallelogram connector 46 extending from the second driven axis 32 to a distal parallelogram axis 48, an intermediate parallelogram connector 64 extending from intermediate lower leg connector axis 52 to an intermediate parallelogram axis 62 and a distal lower connection leg part 44 connecting said intermediate parallelogram axis 62 and the distal parallelogram axis 48.

In other words, distal parallelogram connector 46 is connected to the second driven axis 32 in such a manner that it rotates with the second driven axis 32 when this is rotated but can freely slide along the second driven axis 32 using a splined shaft or grooved shaft as mentioned above.

Said parallelogram connections may be provided one or more times in order to increase the transmitted torque and prevent singularities of the mechanism that result from singularities of the parallelograms. In the embodiment depicted in in FIGS. 1, 2 and 3, the lower leg mechanism is provided with two parallelogram connections. Other embodiments might provide additional parallelogram connections also in the distal part of the upper leg mechanism or in the proximal parts of the upper and/or lower leg mechanism.

Although the embodiment shown in FIGS. 1 to 3 comprises a double distal parallelogram mechanism with the references 44′, 46′ and 64′, the respective elements are best seen in FIG. 3, since they are partly hidden behind the support arm 42. The double distal parallelogram is attached on the distal upper support arm 42 in the same way as the distal lower parallelogram mechanism with its elements 44, 46 and 64. The double distal parallelogram mechanism comprises a double distal parallelogram connector 46′, a double distal connection leg part 44′ and a double distal intermediate parallelogram connector 64′, wherein one end of the double distal parallelogram connector 46′ is connected to rotate in a torque proof manner with the second driven axis 32, wherein the double distal connection leg part 46′ and the double distal intermediate parallelogram connector 64′ are rotatably connected in series between the double distal parallelogram connector 46′ and said intermediate axis 52.

The different attachments between the lower parallelogram mechanism and the double distal parallelogram mechanism is the way the distal parallelogram connectors 46 and 46′ are attached at the driven axis 32 and the intermediate parallelogram connector 64 and 64′ are connected to the intermediate parallelogram connector 56.

Both parallelogram connections are connected with axis 31/32 and axis 51/52 for free rotation.

On axis 51 and 52, respectively are provided, separated by a spacer 59 from the hereto described distal upper guide leg part 41 and intermediate parallelogram connector 63, the proximal upper guide leg part 71 and intermediate parallelogram connector 55, and separated by a spacer 59 from the hereto described distal lower guide leg part 42 and intermediate parallelogram connector 64, the proximal upper guide leg part 72 and intermediate parallelogram connector 56.

The proximal upper guide leg 71 and the proximal lower guide leg 72 are connected to the intermediate connector axis 51 and 52, respectively, for being freely rotatable. The connection is such that moving the axis 51 or 52 through a driven movement of the intermediate parallelogram axis 63 or 64, respectively, move the intermediate parallelogram connector 55 or 56, respectively.

The proximal upper guide leg 71 is connected with said upper leg cuff attachment rod 21 and the proximal lower guide leg 72 is connected with said lower leg cuff attachment rod 22 at upper transfer axis 77 and at lower transfer axis 78, respectively.

In parallel (not in the mathematical sense) to the proximal upper guide leg 71 is provided a parallelogram connection comprising intermediate parallelogram connector 55, which is connected to a proximal upper connection leg part 53 at intermediate parallelogram axis 57, and an proximal parallelogram connector 75, which is connected to said proximal upper connection leg part 53 on the opposite end at proximal parallelogram axis 73 and with the upper transfer axis 77.

In parallel (not in the mathematical sense) to the proximal lower guide leg 72 is provided a parallelogram connection comprising intermediate parallelogram connector 56, which is connected to a proximal lower connection leg part 54 at intermediate parallelogram axis 58, and a proximal parallelogram connector 76, which is connected to said proximal lower connection leg part 54 on the opposite end at proximal parallelogram axis 74 and with the lower transfer axis 78.

The upper and lower transfer axis 77 and 78 are fixedly connected to the rods 21 and 22 for a transfer of torque and guide energy stemming from axes 31 and 32 and delivered by rods 43/53 and 44/54.

Parallelogram constructions are well known in the art. When the first driven engagement 33 is activated and the distal upper guide leg part 41 is not moved by the user or otherwise, the parallelogram built from elements 41, 45, 63 and 43 is deformed, the axis 51 rotates correspondingly to axis 31 and the lengths of parallelogram sides. The upper leg cuff attachment rod (21) rotates corresponding to the rotation of axis 51 and the lengths of the parallelogram sides built from elements 71, 55, 53 and 75. During such a driven moment or even without a driven parallelogram, the rod 21 can be pushed laterally such that it moves laterally because the whole upper mechanism slides laterally on the first driven axis 31. Furthermore, the free rotation of distal upper guide leg part 41 at axes 31 and 51 and of proximal upper guide leg part 71 at axes 51 and 77 allows for free translation of the upper leg cuff attachment 21 (and upper transfer axis 77) in upward and downward, as well as forward (users orientation) and backward direction. In summary, while the rotation of upper leg cuff attachment 21 around upper transfer axis 77 is driven by the first driven axis 31, the translation of upper leg cuff attachment 21 is freely possible in 3 dimensions. The range of motion of this translation is only limited by the length of the sliding range on the driven axis and the lengths and rotational ranges of motion of elements 41 and 71.

The lengths of upper elements 41 and 71 are longer than those of the corresponding elements 42 and 72 so that it is in principle possible that the distal upper guide leg part 41 is positioned right of the distal lower guide leg part 42 when seen in a front view as FIG. 2.

Furthermore, the lengths of upper elements 41 and 71 are longer than those of the corresponding elements 42 and 72 so that it is in principle possible that the upper and lower leg cuff attachment rod can be aligned to the leg when seen in a front view as FIG. 2.

An advantage over prior art solutions of the present apparatus is the possibility to follow a natural movement of one or both legs, which do not simply stay one above the other but can be rotated around an axis in the direction of the leg, since the two connections are independent from one another and any transversal shift of the upper or lower leg can be followed by a transversal movement of the parts 41 and 42 on the axes 31 and 32. Furthermore, it is easier connect a user to the apparatus, since only two cuffs are to be positioned in front of the user independent from the stance or sitting posture of the user, e.g. if the user stands with feet shoulder width apart or in a closed stance, since the rods 21 and 22 can be easily moved in the transversal direction. Finally, any weight support unit can be freely positioned above or behind the user and does not interfere with the cuff attachment as is still the case in WO 2014/202767.

The embodiment shown in FIGS. 1 to 3 show an attachment of the leg actuation mechanism frames 30 at the main frame being a treadmill frame. It is also possible that the main frame is an apparatus for gait training as disclosed in WO 2016/005367 A1 of the present applicant, wherein the present leg actuation mechanism frames 30 are attached at the so-called bases 201 and 202 of WO 2016/005367 A1, replacing the so-called orthosis linear drives 701 and 702 as shown in FIG. 3 of said document.

The distal guide leg parts 41 and 42 are, in a view from the front, inclined towards the center of frame 10, i.e. away from the driven axis 31 and 32. The distal upper connection leg part 43 is connected to driven axis 31 on the inside (towards the frame 10) of the distal guide leg part 41 and connected to the intermediate upper leg connector axis 51 on the outside, whereas one distal lower connection leg part 44 is connected to driven axis 32 and to the intermediate lower leg connector axis 52 on the inside (towards the frame 10) of the distal guide leg part 42 while the second lower leg connection part 44 is connected to the outside of those.

The proximal guide leg parts 71 and 72 are, in a view from the front, inclined towards the center of frame 10, i.e. away from the driven axis 31 and 32. The proximal upper connection leg part 53 is connected to intermediate axis 51 on the inside (towards the frame 10) of the proximal guide leg part 71 and connected to the upper transfer axis 77 on the outside. The same principle is applied for the proximal lower connection leg part 54 which is connected to intermediate axis 52 on the inside (towards the frame 10) of the proximal guide leg part 72 and is connected to the lower transfer axis 78 on the outside.

In other embodiments the proximal or distal leg parts may not be inclined, as described above, or the elements may not be systematically placed on the inside of each other, as described above, such that in these embodiments all elements of either or both of the proximal and distal parallelograms are essentially in one plane perpendicular to the driven axis. Such embodiments could additionally include a treadmill, in which case the driven axes may be placed in front of the treadmill.

The elements of the parallelograms would preferably always be essentially in front of the cuff attachments with respect to walking direction of the user.

The proximal connection leg parts 53 and 54 comprise force sensors 81 and 82, respectively, for determining the torque applied by the mechanism to the leg cuff attachment rods 21 and 22, respectively. These force sensors may help improving the control of the apparatus and the driven axis, but they may be omitted in certain embodiments if forward control of the driven axes is sufficient or other sensors are implemented and used for controlling the apparatus. The choice of location of the force sensors 81, 82 in the proximal connection leg parts 53, 54 allows to measure the torque around the upper and lower transfer axis 77, 78 respectively, with little side effects and high accuracy. Different embodiments may contain different force sensing methods, like load cells, piezoelectrical force transducers, spring-based force sensors to name a few.

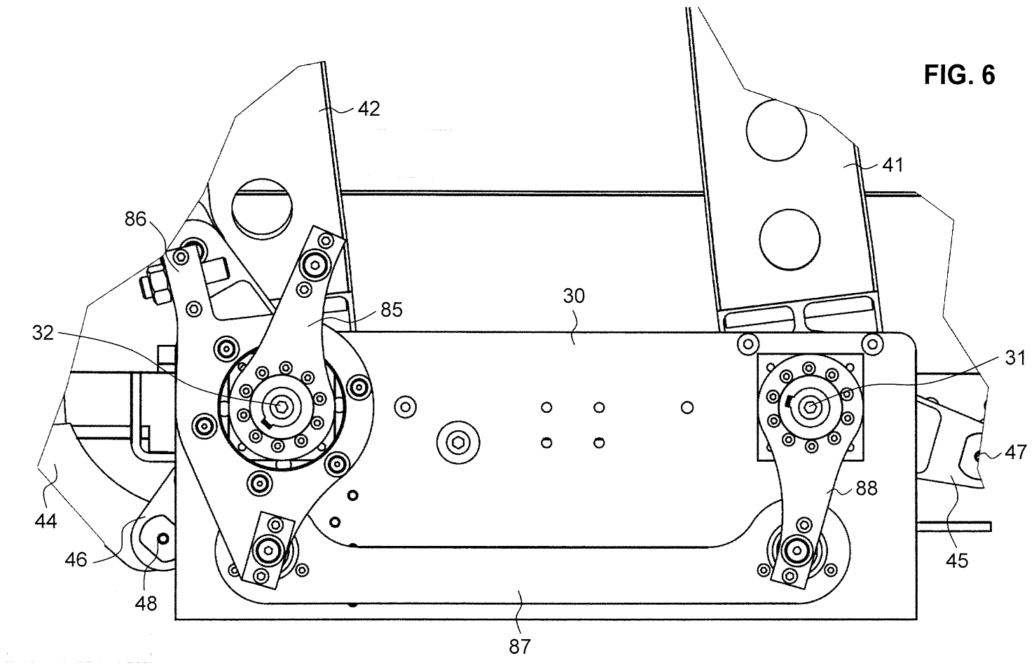

FIG. 6 shows a detail side view of the attachment of the driven axes 31 and 32 of FIG. 1. The legs actuation mechanism frame 30 preferably comprises one or more abutments 85 to limit the movement of the lower leg mechanism in dependence of the movement of the upper leg mechanism, especially avoiding to overstretch the knee joint. This knee joint protection mechanism increases the devices safety by providing a mechanical limitation for the movement of the lower leg cuff attachment 22 in dependence of the rotation of the upper leg cuff attachment 21. This limitation allows only that the angle between upper leg cuff attachment 21 and lower leg cuff attachment 22 is an essentially convex angle with respect to the leg during all times. It prevents a substantially concave angle that would hyperextend the knee. The limit for the angle is in the range of 0° to 10°, preferably in the range of 4° to 5°. In certain embodiments, the limit might be adjustable to the anatomy of the user. The knee joint protection mechanism consists of an abutment 85 fixedly connected to the second driven axis 32. A limiter 86 rotatably connected to the second and an axes linkage 87. Such axes linkage 87 connected to the first driven axis 31 by an axis connector 88. The axis connector 88 is fixedly connected to first driven axis 31. The axes linkage 87 and axis connector 88 provide that, if the first driven axis 31 is rotated by a certain angle, the limiter 86 rotates around the second driven axis 32 by the same angle. In the embodiment depicted in FIG. 6, the axes linkage 87 is shown as a rigid bar extending between the part of the abutment 85 that is proving a lever arm and an axis connector 88 that is provided as an arm connected to the first driven axis 31. In other embodiments the axes linkage 87 may be provided as a chain which connects to an axis connector 88 provided as a sprocket. Other embodiment may transmit the rotation of the first driven axis 31 to the abutment 85 via toothed belts, one or more gear wheels or bevel gear wheels.

When the cuff attachment elements 21 and 22 are positioned one above the other, then the two intermediate axis 51 and 52 are positioned parallel adjacent in their longitudinal direction, which means that in a view from the front, i.e. in opposite walking direction, the ends of the proximal guide leg parts 71 and 72 rotatably attached to the intermediate axes 51 and 52 are positioned one above the other with an offset in the walking direction. The same is true for the ends of the distal guide leg parts 41 and 42 rotatably attached to these intermediate axes 51 and 52. Of course the possibility for both leg attachments to slide via the distal guide leg parts 41 and 42 along the direction of the driven axes 31 and 32, i.e. in the direction of the double arrow 35.

In other embodiments (not shown in the drawings), the cuff attachments 21/22 are attached from the backside of the legs against the fibula in the lower part and from behind against the thigh. Then the entire actuation devices are positioned behind the user, so that the user does not see these elements while walking,

In some embodiments one or more of the cuff attachments 21/22 can be rotated around an additional axis perpendicular to axis 77/78, respectively, especially one that is also perpendicular to the main part of the attachment surface of 21/22, respectively. This additional rotation axis may increase the comfort of the user.

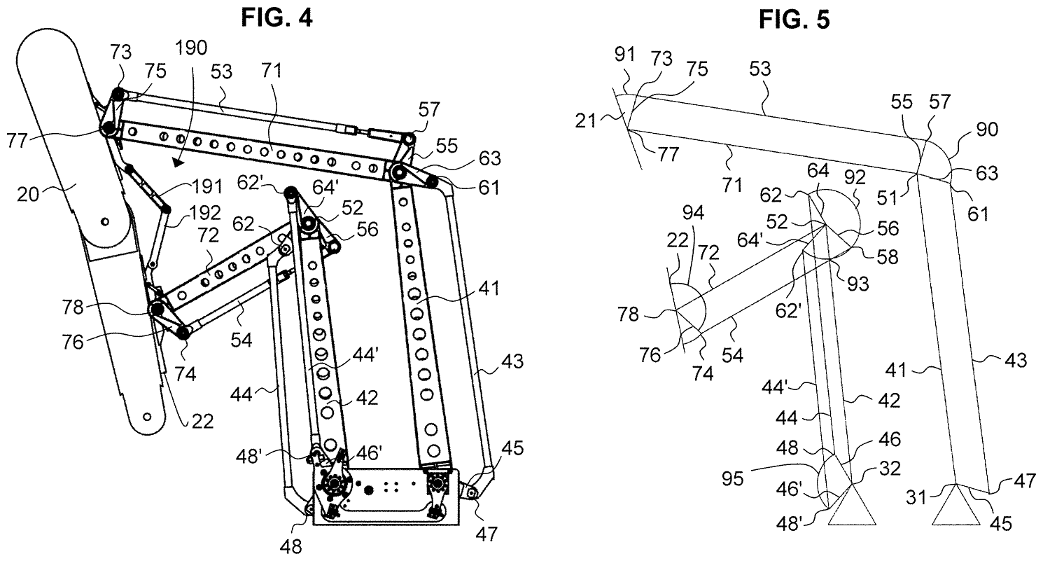

FIG. 4 shows a further side view similar to FIG. 3, and FIG. 5 shows a schematic view of the side view of the apparatus of FIG. 4 with respect to the arms, especially the arms of the different parallelogram mechanisms, if two distal parallelograms are provided.

FIG. 4 shows an embodiment that comprises a knee rotation protector 190. The depicted embodiment comprises two bars 191, 192, e.g. metal bars, that are connected with each other by an axis at one of their ends and with their other ends via further axes to the upper leg attachment rod 21 and the lower leg attachment rod 22 respectively. These axes are oriented parallel to each other such the surfaces of the attachment rods 21, 22 can be rotated relative to each other only in one axis, which is an axis that is parallel to said three axes. These components allow for additional guidance and protection of a user's knee when applied to a user's leg.

Additionally to the mechanical links depicted in FIG. 5, several angles are introduced in FIG. 5. These angles 90, 91, 92 and 93 are defined through fixation between different connectors as shown in Table 1. The intermediate axis connectors of the distal parallelograms, i.e. the parallelograms which are attached to the driven axes 31 and 32, form an angle 90 with the intermediate axis connectors of the proximal parallelograms between 60 and 120 degrees, preferably 90 degrees. Ideally 90° would provide for the lowest possible force on the pushrods for a given torque. A reason for taking a different angle is to make parts fit for all four links and to make the pushrods go past the connection axels in all positions. An angle of 40° instead of the above-mentioned lower angle 60 degrees would still work, it would just put a higher load on the pushrods, so that the interval of angles can be chosen in both cases as from 40 to 120 degrees. This is the case, if there is only one distal parallelogram. Preferably, two distal parallelograms are arranged to avoid a dead center which appears especially at the lower leg mechanism if only one distal parallelogram would be provided. An angle of between 60 and 120 degrees is provided between the distal connectors 46 and 46′ at the driven axis 32. The preferred choice for 90 degrees is based on the same rationale as explained above. Beside the above mentioned one angle 92 of between 60 and 120 degrees, the second angle 93 between the intermediate connectors of the second distal parallelogram and the connector of the proximal parallelogram is provided on the other side of the connector 64 and has a value between 130 and 190 degrees. This angle is designed to rotate the pushing force that transmits the torque to the best possible angle for the proximal links. Best possible in the way that there is the biggest passive translational and active rotational workspace given the dependencies of a gait trajectory. This is not necessarily an angle in the interval as mentioned.

TABLE 1

| Angle between | Actual value | Reference numeral |
|---|---|---|
| 63/55 | 90° | 90 |
| 75/21 | 36° | 91 |
| 64/56 | 90° | 92 |
| 64′/56 | 162° | 93 |
| 64/64′ | 108° | Equal to 360°-angle 92-angle 93 |
| 76/22 | 144° | 94 |
| 46/46′ | equal to 64/64′ | 95 |

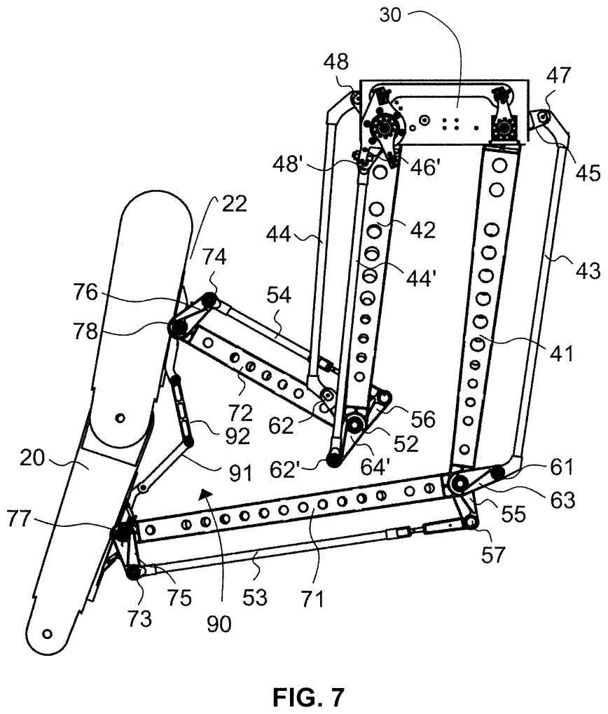

FIG. 7 shows a schematic side view of parts of a second gait rehabilitation apparatus with a leg model similar to the embodiment as shown in FIG. 3 with an above ground mount of the legs actuation mechanism frame 30. It is named as “above head” but in FIG. 7 the frame 30 is just at the height of the hip or trunk of a user when comparing with the leg model 20. When comparing the reference numerals of the leg actuation apparatus 40 between the embodiment of FIG. 3 and FIG. 7, it is clear that they are identical at the same positions beside that the distal upper guide leg part 41 is now the distal lower guide leg part; the corresponding proximal upper guide leg part 71 the proximal lower guide leg part and the same applies to the distal lower guide leg part 42 being in FIG. 7 the distal upper guide leg part and the proximal lower guide leg part 72 becoming the proximal upper guide leg part. The function of the device is identical. Only the frame 30 is not standing on the ground or connected to a main frame as a tread mill frame 10 but to an above ground main frame, which can directly provide the weight support system at one or more vertical bars and e.g. rollers at the lower ends of the bar for a free movement of the user.

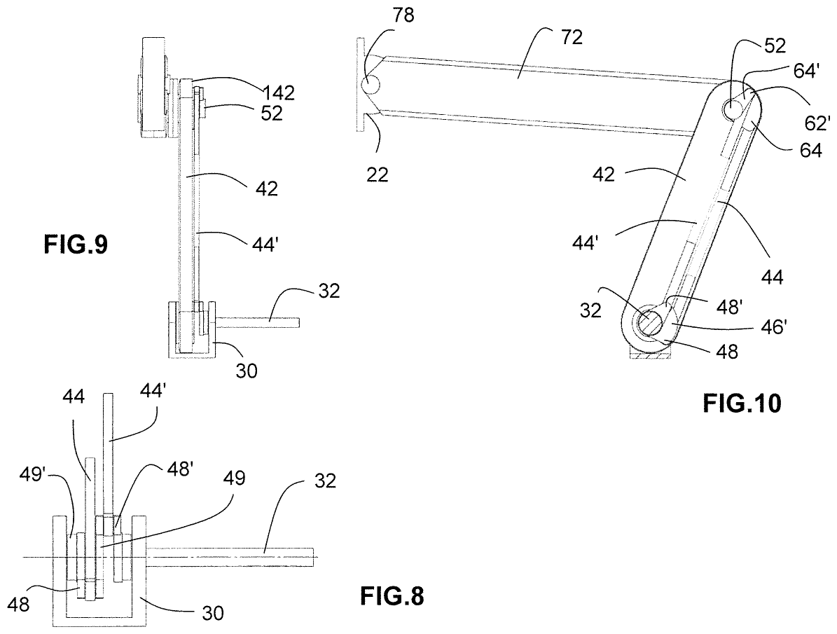

FIG. 8 shows a front view of a portion of a different crank mechanism provided for a further embodiment of a leg actuation apparatus without the distal lower guide leg part 42, omitted in this detail view. FIG. 9 shows a further front view on the mechanism according to FIG. 8 with the elements of the guide leg part 42 covering the distal lower connection leg part; and FIG. 10 shows a side view on the mechanism according to FIG. 8, incorporating the connection at the intermediate lower leg connector axis. The present crank mechanism 49, 49′ with connection to driven axis 32 is a 360 degree mechanism without a dead point but the main advantage of the crank mechanism is that the lower distal parallelogram mechanisms 44, 46 and 64 and “double” 44′, 46′ and 64′ can easily be fitted are inside the support arm 42 so that a user cannot insert objects and thus his fingers/hands between the bars and pinch them. The encompassing support arm 42 avoids this. The embodiment as shown in FIG. 9 has arm 44′ just beside the edges of support arm 42 but the circumferential side edges 142 could be higher over the base plate to cover the arm 44′ as well.

Although this crank mechanism is only shown in connection with the distal lower guide leg part 42, it would in view of FIG. 7 also usable for the distal upper leg part in the above ground case. Furthermore, it can also be applied to the proximal lower and upper guide leg parts for protecting the user's hands and fingers. At this place, the advantage of avoidance of a dead center is not paramount.

The crankshaft element 49 provides the connection via 48 to crankshaft element 49′ within the frame 30 on one side and via 48′ to driven axis 32 reaching through the frame 30. Therefore, as can be seen in FIG. 8 the two arms 44 and 44′ can rotate freely and only need to have a movement limiting stop to protect the user's joints.

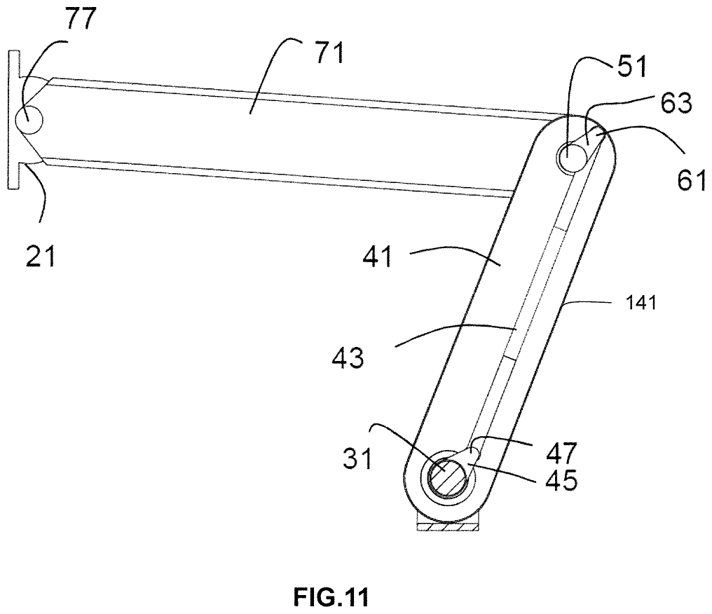

FIG. 11 shows a schematic perspective view of parts of a further gait rehabilitation apparatus for the upper leg, or to be used as a simpler version for the lower leg similar to FIG. 10. In fact, similar to FIG. 10 showing a different embodiment relating to the lower leg attachment as shown in FIG. 5 on the left side (same numerals), FIG. 11 is showing a different embodiment relating to the upper leg attachment as shown in FIG. 5 on the right side, where only one arm 43 is hidden inside the arm 41 which has a plate, e.g. in the drawing plane, and an orthogonally extending oval circumferential edge 141. This edge is provided around the two axis 31 and 51 in a distance that the free ends of the parallelogram connectors 45 and 63 opposite to axes 31 and 51 respectively stay inside the oval circumferential edge 141. This can easily be seen with the axis 61 of connector 63 being inside the half circle of the oval circumferential edge 141.

It is clear in view of the chosen identity or similarity of the reference numerals that the embodiment for one leg of FIG. 1 can be combined with the protection arms of FIG. 11 and/or can be mounded above ground as shown in FIG. 7.

1-16. (canceled)

17. A leg actuation apparatus for a user with a leg actuation mechanism frame comprising:
a first driven axis positioned transverse to the walking direction of said user,
an upper attachment element for a first leg part of the user, comprising a transverse upper transfer axis,
a distal upper parallelogram mechanism, comprising a distal upper support arm, a distal upper parallelogram connector, a distal upper connection leg part and a distal upper intermediate parallelogram connector, wherein one end of the distal upper support arm is attached in a rotatable manner at the first driven axis, wherein the other end of this distal upper support arm is providing an intermediate axis for the distal upper parallelogram mechanism, wherein one end of the distal upper parallelogram connector is connected to rotate in a torque proof manner with the first driven axis, wherein the distal upper connection leg part and the distal upper intermediate parallelogram connector are rotatably connected in series between the distal upper parallelogram connector and said intermediate axis, and
a proximal upper parallelogram mechanism, comprising a proximal upper support arm, a proximal upper intermediate parallelogram connector, a proximal upper connection leg part and a proximal upper parallelogram connector, wherein one end of the proximal upper support arm is attached in a rotatable manner at the intermediate axis, wherein the other end of this proximal upper support arm is rotatably attached at the upper transfer axis, wherein the proximal upper intermediate parallelogram connector, a proximal upper connection leg part and a proximal upper parallelogram connector, are rotatably connected in series between said intermediate axis and said upper transfer axis, wherein the distal upper intermediate parallelogram connector and the proximal upper intermediate parallelogram connector are connected to rotate in a torque-proof manner and the proximal upper parallelogram connector and upper attachment element are connected to rotate in a torque-proof manner.

18. The leg actuation apparatus according to claim 17, wherein a double distal parallelogram mechanism is attached on the distal upper support arm, wherein the double distal parallelogram mechanism comprises a double distal parallelogram connector, a double distal connection leg part and a double distal intermediate parallelogram connector, wherein one end of the double distal parallelogram connector is connected to rotate in a torque proof manner with the first driven axis, wherein the double distal connection leg part and the double distal intermediate parallelogram connector are rotatably connected in series between the double distal parallelogram connector and said intermediate axis.

19. The leg actuation apparatus according to claim 18, wherein the angle between the distal parallelogram connector and the double distal parallelogram connector is between 40 and 120 degrees, preferably between 60 and 120 degrees and especially 90 degrees.

20. The leg actuation apparatus according to claim 17, wherein the distal ends of the upper parallelogram mechanism can freely glide along the first driven axis.

21. The leg actuation apparatus according to claim 17, wherein the distal ends of the upper parallelogram mechanism are connected to an actuator for a driven movement along the first driven axis.

22. The leg actuation apparatus according to claim 17, further comprising abutments for fixing the extreme positions of the distal ends of the upper parallelogram mechanism on the first driven axis.

23. The leg actuation apparatus according to claim 17, wherein the distal upper support arm consists of a protective base plate being surrounded by a circumferential edge extending orthogonally from said protective base plate, wherein the circumferential edge surrounds the distal upper parallelogram connector and the distal upper intermediate parallelogram connector in a way that the distal upper connection leg part remains inside the space defined by the protective base plate and the circumferential edge.

24. The leg actuation apparatus according to claim 17, wherein the leg actuation mechanism frame further comprises:
a second driven axis positioned parallel to the first driven axis,
a lower attachment element for a second leg part of the user, comprising a transverse lower transfer axis,
a distal lower parallelogram mechanism, comprising a distal lower support arm, a distal lower parallelogram connector, a distal lower connection leg part and a distal lower intermediate parallelogram connector, wherein one end of the distal lower support arm is attached in a rotatable manner at the second driven axis, wherein the other end of this distal lower support arm is providing an intermediate axis for the distal lower parallelogram mechanism, wherein one end of the distal lower parallelogram connector is connected to rotate in a torque proof manner with the second driven axis, wherein the distal lower connection leg part and the distal lower intermediate parallelogram connector are rotatably connected in series between the distal lower parallelogram connector and said intermediate axis, and
a proximal lower parallelogram mechanism, comprising a proximal lower support arm, a proximal lower intermediate parallelogram connector, a proximal lower connection leg part and a proximal lower parallelogram connector, wherein one end of the proximal lower support arm is attached in a rotatable manner at the intermediate axis, wherein the other end of this proximal lower support arm is rotatably attached at the lower transfer axis, wherein the proximal lower intermediate parallelogram connector, a proximal lower connection leg part and a proximal lower parallelogram connector, are rotatably connected in series between said intermediate axis and said lower transfer axis, wherein the distal lower intermediate parallelogram connector and the proximal lower intermediate parallelogram connector are connected to rotate in a torque-proof manner and the proximal lower parallelogram connector and lower attachment element are connected to rotate in a torque-proof manner.

25. The leg actuation apparatus according to claim 24, wherein the distal lower support arm consists of a protective base plate being surrounded by a circumferential edge extending orthogonally from said protective base plate, wherein the circumferential edge surrounds the distal lower parallelogram connector and the distal lower intermediate parallelogram connector in a way that the distal lower connection leg part remains inside the space defined by the protective base plate and the circumferential edge.

26. The leg actuation apparatus according to claim 17, wherein a or the one proximal connection leg part comprise a force sensor.

27. The leg actuation apparatus according to claim 17, wherein the legs actuation mechanism frame comprises one or more abutments to limit the movement of the parallelogram mechanism to a set adjustable value defining the maximum knee extension especially avoiding to overstretch the knee joint.

28. An apparatus for gait rehabilitation comprising a main frame providing a possibility for a user to receive support during walking within this main frame and further comprising a first leg actuation apparatus for a user with a leg actuation mechanism frame comprising:
a first driven axis positioned transverse to the walking direction of said user,
an upper attachment element for a first leg part of the user, comprising a transverse upper transfer axis,
a distal upper parallelogram mechanism, comprising a distal upper support arm, a distal upper parallelogram connector, a distal upper connection leg part and a distal upper intermediate parallelogram connector, wherein one end of the distal upper support arm is attached in a rotatable manner at the first driven axis, wherein the other end of this distal upper support arm is providing an intermediate axis for the distal upper parallelogram mechanism, wherein one end of the distal upper parallelogram connector is connected to rotate in a torque proof manner with the first driven axis, wherein the distal upper connection leg part and the distal upper intermediate parallelogram connector are rotatably connected in series between the distal upper parallelogram connector and said intermediate axis, and
a proximal upper parallelogram mechanism, comprising a proximal upper support arm, a proximal upper intermediate parallelogram connector, a proximal upper connection leg part and a proximal upper parallelogram connector, wherein one end of the proximal upper support arm is attached in a rotatable manner at the intermediate axis, wherein the other end of this proximal upper support arm is rotatably attached at the upper transfer axis, wherein the proximal upper intermediate parallelogram connector, a proximal upper connection leg part and a proximal upper parallelogram connector, are rotatably connected in series between said intermediate axis and said upper transfer axis, wherein the distal upper intermediate parallelogram connector and the proximal upper intermediate parallelogram connector are connected to rotate in a torque-proof manner and the proximal upper parallelogram connector and upper attachment element are connected to rotate in a torque-proof manner,
wherein the first leg actuation apparatus being attached to the main frame to support at least one part of a first leg of the user.

29. The apparatus according to claim 28, comprising a second leg actuation apparatus, wherein the first leg actuation apparatus comprises a first leg actuation mechanism frame for the first leg and the second leg actuation apparatus comprises a second leg actuation mechanism frame for the second leg of the user.

30. The apparatus for gait rehabilitation according to claim 28, wherein the main frame comprises a treadmill for the user to walk upon.

31. The apparatus for gait rehabilitation according to claim 28, wherein the main frame comprises at least a set of rolling wheels defining the surface onto which the apparatus for gait rehabilitation is displaced by the walking user.

32. A method for leg actuation and gait rehabilitation of at least one leg of a user comprising the steps of:
providing a leg actuation apparatus for a user according to claim 28, adapted to mimic the movement of a leg of the user,
attaching at least one of the lower and/or upper parts of one leg of the user to said leg actuation apparatus, and
guiding and/or driving the leg actuation apparatus.

33. The method according to claim 32, wherein the attaching step further comprises;
attaching the body of the user at a pelvis attachment of a weight suspension unit;
and the guiding and/or driving step further comprises:
guiding and/or driving the weight suspension unit.
